(19) United States
(12) Patent Application Publication
(10) Pub. No.: US 2004/0014483 A1
(43) Pub. Date: Jan. 22, 2004

(54) Maintenance system for control devices of hydrostatic drives

(76) Inventors: Reinhard Vonnoe, Weissenhorn (DE); Uwe Krummenoehler, Buehl (DE)

Correspondence Address: Leopold Presser, Scully Scott Murphy & Presser, 400 Garden City Plaza, Garden City, NY, 11530, US

(21) Appl. No.: 10/363,958

(22) PCT Filed: Jul. 12, 2001
(86) PCT No.: PCT/EP01/08081

(30) Foreign Application Priority Data
Sep. 8, 2000 (DE) 10044501.2
Nov. 2, 2000 (DE) 10054249.2

(51) Int. Cl. H04M 1/00

(52) U.S. Cl. 455/550.1; 455/562.1; 455/575.7; 455/561

(57) ABSTRACT

The invention relates to a maintenance system for a control device (1) of hydrostatic drives. Said system comprises a control unit (16) and a first interface (12a) that is connected to the control device (1) via a data line (6a), for the bi-directional transfer of data and a maintenance device (3) comprising a second interface (12b) that is connected to the maintenance device (3) via a data line (6b), for the bi-directional transfer of data. The first and the second interface (12a, 12b) have a respective transceiver (4a, 4b) and an antenna (5a, 5b) and data is transferred between the control device (1) and the maintenance device (3) in a wireless manner by radio.

The invention is based on a maintenance system according to the genus of the main claim.

Maintenance systems for control devices of hydrostatic drives are known. They consist of a control device with a control unit and a maintenance device. For data exchange both the control device and the maintenance device have an interface. Cables with corresponding plug connectors link the devices together. Data can be transmitted both from the control device to the maintenance device and in reverse direction. This takes place e.g. via an RS232 interface. By connecting the control device with a maintenance device it is e.g. possible to output error messages or process data or store these in a memory for later analysis. Conversely new parameters can be output from the maintenance device to the control unit. For this the maintenance device has a suitable input device e.g. a keyboard. The maintenance device is either an operating box developed specially for communication with the control device or a laptop.

The disadvantage with the said maintenance system is the data transmission via cables which are connected with the control device and the maintenance device by plug connections. The most common source of errors in data transmission is the plug connection used. Corrosion of the contacts can lead to faulty transmission of data and hence to failure of the maintenance system. In mobile working machines in particular the risk of soiling at the plug contacts is high, where because of contact difficulties errors can likewise occur in the transmission of data.

Also disadvantageous is the financial cost required to install a suitable plug connector. Added to the cost of the actual diagnosis socket is the extra work required for laying to an easily accessible point. For mobile working machines in particular the requirements for plug connections are high in respect of avoiding damage and soiling.

The operator is also restricted in his freedom of movement by the cable connection of the devices.

The invention relates to the object of creating a maintenance system with better handling and greater user-friendliness.

This object is achieved by the characteristic features of claim 1 in conjunction with the generic features.

The maintenance system according to the invention has the advantage that due to the wireless transmission of data by radio, a connection between the control device and the maintenance device by cable can be omitted. This means the plug connections are also not required so the security of the system against failure is substantially improved.

Also a cost saving can be achieved by the omission of plug connectors. As well as the costs of the components, this also applies to installation e.g. of the diagnosis socket.

Operating the maintenance device without a cable connection also increases the user comfort as the user can move freely within the range of the radio connection. In function tests

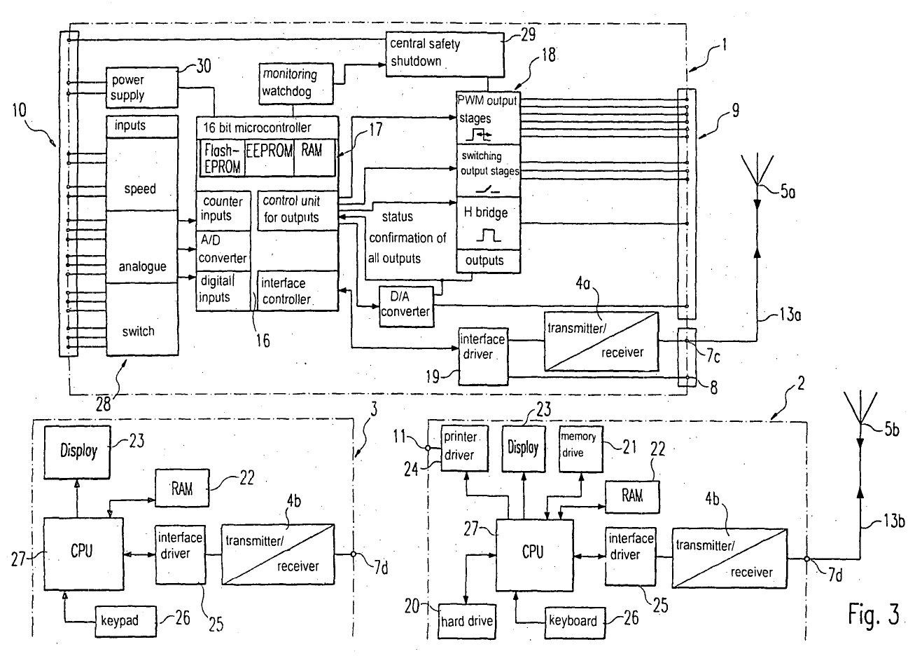

FIG. 3 a block circuit diagram of a second embodiment example of a maintenance system according to the invention.

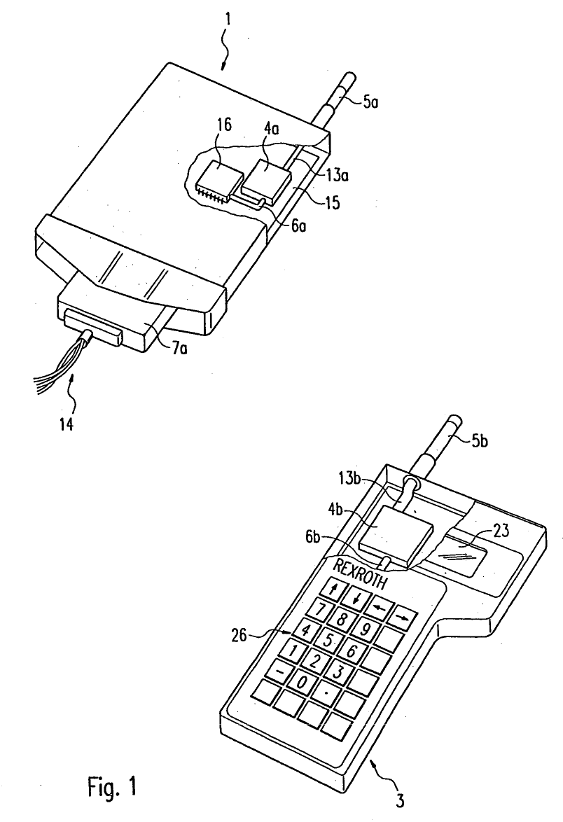

FIG. 1 shows the structure in principle of a maintenance system according to the invention. A control unit 16 of a control device 1, e.g. the mobile working machine not shown, is connected via a data line 6a with a transmitter and receiver unit 4a to which is connected an antenna 5a by means of an antenna cable 13a. The data line 6a used between the control unit 16 and transmitter/receiver unit 4a can e.g. be a conductor track on a circuit board 15 of the control device 1.

The maintenance device, in the embodiment example shown an operating box 3, is connected via a further data line 6b with a second transmitter and receiver unit 4b which in turn is connected via an antenna cable 13b to an antenna 5b. The data is transmitted between the control unit 16 of the control device 1 and the operating box 3 by radio transmission between the two transmitter and receiver units 4a, 4b.

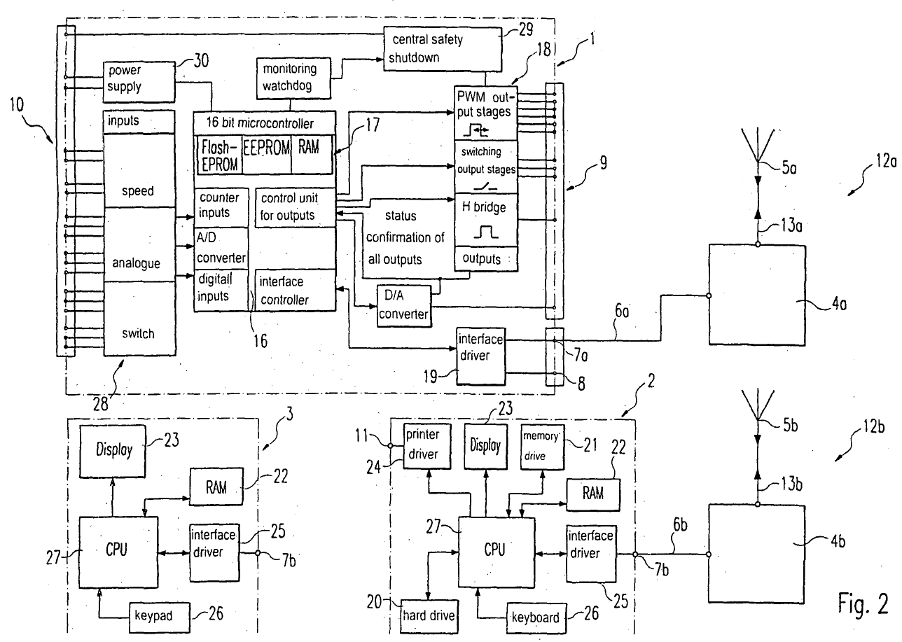

FIG. 2 shows the structure of the maintenance system as a block circuit diagram. The control device 1 has several connections suitable for the application concerned. In the example shown these are four inputs for the signals from rotation speed sensors, six inputs for potentiometers and a further six programmable switch inputs. The input channels 28 are contacted via a plug connection 10. On the output side are provided six proportional magnets and three outputs for switch magnets, relays or similar. In addition there is a further output for an actuator motor and an analogue output e.g. with a voltage from zero to five Volts. The outputs are connected with the individual consumers via a second plug connection 9. Alternatively the inputs and outputs can be arranged in a single common plug connection as shown in FIG. 1.

The measurement and control signals present on the input side, from the rotation speed sensors not shown and the potentiometers not shown, together with the switch settings of the switches not shown, are detected and processed in the control unit 16 of the control device 1. This is done via a program stored in a memory 17 of control unit 16. Also in part of the memory 17 of the control unit 16 are stored system-specific parameters. These parameters can be written new to the memory 17 by the maintenance device. This allows adaptation e.g. to modified conditions of use.

The control parameters calculated by the program of the control unit 16 are transmitted to the end stages 18 of the outputs and converted into corresponding output parameters of suitable power. The status of the outputs contacted via plug connection 9 by the consumers not shown is reported back to the control unit 16. On an error, the system can be shut down via a central safety shut-off 29.

To communicate with other devices e.g. the control electronics of a diesel engine, the control device 1 has a bi-directional connection 8 which allows integration in a CAN-bus not shown and which is triggered via an interface driver 19. The transmitter/receiver unit 4a is also triggered via the interface driver 19. The connection is made via the plug connection 7a and the data line 6a. The transmitter/receiver unit 4a is connected with an antenna 5a via antenna cable 13a.

In the same way, in a communicating maintenance device which e.g. can be an operating box 3 or a laptop 2, a transmitter/receiver unit is connected with the second transmitter/receiver 4b by means of a further data line 6b and a plug connection 7b, and a further antenna 5b is connected therewith via an antenna cable 13b.

The further description relates to the use of a laptop 2 as a maintenance device. An operating box 3 specially developed for maintenance purposes is used in a corresponding manner, so no separate description is given.

Software matched to the control unit 16 is installed on the laptop 2. An error memory integrated in the control device 1 as part of the memory 17 of the control unit 16 can be read and stored on a hard disk 20 or another memory 21 of the laptop 2. Direct output to a display 23 is also possible, as is a print-out of the information via a printer not shown which is connected via a plug connection 11 and a corresponding interface driver 24 with the processor 27.

By reversing the direction of data transmission it is possible to adapt the parameters used by the program of the control unit 16. For this firstly a direct input can be made via the keyboard of the laptop 2 or a preproduced data record can be transmitted from one of the memory media of the laptop 2.

Using the example of data transmission of the fault memory to the laptop 2, the working method of the maintenance system will be explained in detail.

The data to be transmitted from the error memory are passed from an interface driver 19 to the first transmitter/receiver unit 4a. There they are converted into radio signals which are passed via antenna cable 13a to the first antenna 5a from which they are emitted. The second antenna 5b receives the radio signal and passes it to the second transmitter/receiver unit 4b. The radio signal from the transmitter/receiver unit 4b is converted back to data and passed via a plug connection 7b and an interface driver 25 corresponding to the second transmitter/receiver unit 4b to the processor 27 of the laptop 2. The system is bi-directional so the data is transmitted from the laptop 2 to the control device 1 in the reverse direction.

FIG. 3 shows a second embodiment example. The first transmitter/receiver unit 4a is integrated in the housing of the control device 1. The first antenna 5a is contacted via a plug connection 7c accessible from the outside on the housing of the control device 1. The first transmitter/receiver 4a is preferably connected directly with the control unit 16. For this the first transmitter/receiver unit 4a is e.g. integrated on the circuit board 15 of the control device 1. The transmitter/receiver unit 4a can also be arranged on an auxiliary circuit board, where the auxiliary circuit board makes contact with the circuit board 15 of the control unit 16 e.g. in the form of a plug card system.

The second transmitter/receiver unit 4b is in turn integrated inside the laptop 2. As in control device 1, integration can be achieved by arranging the second transmitter/receiver unit 4b on a common circuit board or an auxiliary circuit board which is connected with the circuit board of processor 27 e.g. by a plug connection. The arrangement of the transmitter/receiver unit 4b can be designed e.g. as a plug card which can be connected with second antenna 5b via a plug contact 7d accessible from outside the housing.

The transmitter/receiver units 4a, 4b together with the respective antennae 5a, 5b can be arranged inside the control device 1 or maintenance device. The transmitter/receiver units 4a, 4b together with antennae 5a, 5b are accommodated in the housing of the control device 1 or laptop 2. The transmitter/receiver units 4a, 4b are connected as explained in FIG. 2. The antennae 5a, 5b are preferably also arranged directly on the circuit boards.

A mobile telephone not shown can also be used as a maintenance device. For example the data read by the control device can thus be passed to a central processing point. There the data can be analysed on a computer by colleagues. As a result of such central analysis e.g. modified parameter sets can be returned to the mobile telephone and transferred from the mobile telephone to the control device 1. Maintenance work which cannot be resolved by a colleague in mobile service alone can however be performed with the help of internal staff.

1. Maintenance system for a control device (1) of hydrostatic drives with a first interface (12a) for bi-directional data transmission connected via a data line (6a) with a control unit (16) of the control device (1), and a maintenance device (3) with a second interface (12b) for bi-directional data transmission connected via a data line (6b) with the maintenance device, characterised in that the first and second interfaces (12a, 12b) each have a transmitter/receiver (4a, 4b) and an antenna (5a, 5b) and the data transmission between the first and the second interfaces (12a, 12b) takes place wireless by radio.

2. Maintenance system according to claim 1, characterised in that the first transmitter/receiver (4a) is arranged in the control device (1).

3. Maintenance system according to claim 1 or 2, characterised in that the second transmitter/receiver (4b) is arranged in the maintenance device (3).

4. Maintenance system according to claim 2, characterised in that the antenna (5a) is arranged in the housing of the control device (1).

5. Maintenance system according to claim 3, characterised in that the antenna (5b) is arranged in the housing of the maintenance device (3).

6. Maintenance system according to any of claims 1 to 5, characterised in that the first interface is an RS 232 or a CAN-bus interface.
